(19) United States
(12) Patent Application Publication
(10) Pub. No.: US 2016/0011141 A1
(43) Pub. Date: Jan. 14, 2016

(54) RADIATION SENSOR

(71) Applicant: EMPIRE TECHNOLOGY DEVELOPMENT LLC, Wilmington, DE (US)

(72) Inventor: Yansong Gu, Bellevue, WA (US)

(21) Appl. No.: 14/770,756

(22) PCT Filed: Mar. 15, 2013
(86) PCT No.: PCT/US13/32288

§ 371 Date: Aug. 26, 2015

(51) Int. Cl. G01N 27/327; G01T 1/16; G01N 27/20

(52) U.S. Cl. CPC G01N 27/3278; G01N 27/20; G01T 1/1606

(57) ABSTRACT

An apparatus includes a first electrode and a second electrode positioned a distance from the first electrode. The second electrode is in electrical communication with the first electrode through at least a portion of a double strand deoxyribonucleic acid (DNA). The apparatus also includes a detector configured to detect a conductivity of the double strand DNA.

### BACKGROUND

The following description is provided to assist the understanding of the reader. None of the information provided or references cited is admitted to be prior art.

One source of low dose radiation includes exposure to diagnostic imaging. Examples of such diagnostic imaging include full body scanners at airport checkpoints and various medical imaging instruments. Individuals who have experienced multiple exposures of low dose radiation could harbor an accumulated dose above the recommended yearly dose. The long term health risk of low dose radiation exposure remains a challenging issue for scientists. One issue is the extent to which an individual's radiation exposure causes DNA damage. In this context, low dose radiation becomes toxic when a single DNA strand breaks. Natural repair of DNA damage varies among individuals, and, therefore, may not be a reliable indicator of DNA damage for all people. For those individuals whose ability to repair DNA damage may not be sufficient or efficient, the long term health risks can be significant.

### SUMMARY

An illustrative apparatus includes a first electrode and a second electrode positioned a distance from the first electrode. The second electrode is in electrical communication with the first electrode through at least a portion of a double strand deoxyribonucleic acid (DNA). The apparatus also includes a detector configured to detect a conductivity of the double strand DNA.

An illustrative method of detecting radiation exposure includes determining a first conductivity of a double strand DNA. A second conductivity of the double strand DNA is also determined. The first conductivity and the second conductivity are determined by measuring electric current through a first electrode and a second electrode. The first electrode is in electrical communication with the second electrode through at least a portion of the double strand DNA. The first conductivity is compared to the second conductivity to determine whether there is a change in conductivity of the double strand DNA. The change in conductivity is indicative of an exposure of the double strand DNA to radiation.

An illustrative non-transitory computer-readable medium has computer-readable instructions stored thereon for execution by a computing device. The computer-readable instructions include instructions to determine a first conductivity and a second conductivity of a double strand DNA. The first conductivity and the second conductivity are determined by measuring electric current through a first electrode and a second electrode. The first electrode is in electrical communication with the second electrode through at least a portion of the double strand DNA. The computer-readable instructions also include instructions to determine a change in conductivity of the double strand DNA based on the first conductivity and the second conductivity.

An illustrative method of making a radiation sensor includes placing a double strand DNA between a first electrode and a second electrode. The method also includes linking the double strand DNA to at least one of the first electrode and the second electrode. The method further includes placing a detector into contact with the first electrode and the second electrode. The detector is configured to determine whether there is a change in conductivity of the double strand DNA.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 is a diagram illustrating one embodiment of a radiation sensor used to detect radiation induced breaks in deoxyribonucleic acid (DNA) in accordance with an illustrative embodiment.

FIG. 2 illustrates three strands of DNA mounted to an electrode in accordance with an illustrative embodiment.

FIG. 3 illustrates two ways that radiation can cause breaks in a double strand DNA in accordance with an illustrative embodiment.

FIG. 4 illustrates a portion of a radiation sensor with flat, sheet-like electrodes in accordance with an illustrative embodiment.

FIG. 5a illustrates a single-walled carbon nanotube in accordance with an illustrative embodiment.

FIG. 5b illustrates a double-walled carbon nanotube in accordance with an illustrative embodiment.

FIG. 6 is a flow chart illustrating one method of detecting radiation induced damage to DNA in accordance with an illustrative embodiment.

FIG. 7 is a flow chart illustrating one method of fabricating a sensing element of a radiation sensor in accordance with an illustrative embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

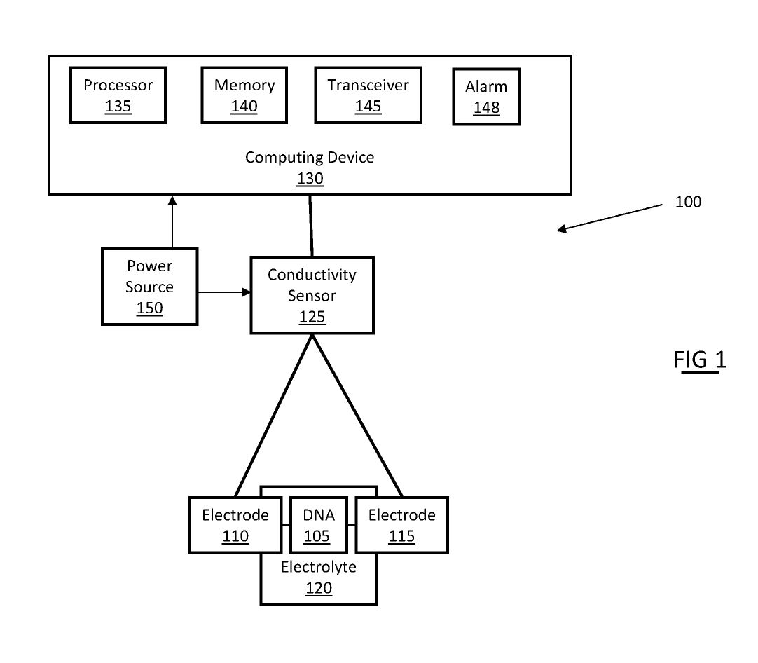

FIG. 1 is a diagram illustrating one embodiment of a radiation sensor 100 used to detect radiation induced breaks in deoxyribonucleic acid (DNA) in accordance with an illustrative embodiment. Radiation sensor 100 includes DNA 105, electrode 110, electrode 115, electrolyte 120, conductivity sensor 125, computing device 130, and power source 150. In alternative embodiments, radiation sensor 100 may include additional, fewer, and/or different elements. As discussed in detail below, radiation sensor 100 operates such that changes in conductivity of DNA 105 are used identify damage to DNA 105 that results from radiation exposure.

When worn by a user, which can be a human user or a non-human user as discussed below, radiation sensor 100 can alert the user that his/her/its accumulated radiation dose may be causing cellular damage. The rationale is that, if DNA 105 in radiation sensor 100 is damaged due to radiation exposure, the DNA of the user wearing radiation sensor may also have been damaged due to the radiation exposure. However, damage to DNA 105 in radiation sensor 100 may represent an absolute value of radiation-induced DNA damage in the absence of any repair activity, whereas the DNA of the user may be repaired sooner or later, or may not even be repaired. This is because most individuals have at least some capacity to repair damaged DNA, however other individuals have little or no ability to repair their DNA once it becomes damaged. Radiation sensor 100 can be worn continuously by a user such that DNA 105 in radiation sensor 100 is exposed to any radiation encountered by the user. Alternatively, radiation sensor 100 may be worn by the user at times when the user expects to be exposed to radiation such as when the user goes through airport security, when the individual has x-rays and other medical procedures, etc. In another embodiment, radiation sensor 100 may be placed and left at a location where it is expected that radiation may be present. For example, radiation sensor 100 may be placed in a nuclear power plant to determine if damage to DNA 105 occurs as a result of radiation exposure at the nuclear power plant. Radiation sensor 100, in some configurations, monitors DNA 105 in the absence of any form of DNA damage repair. Alternatively, radiation sensor 100 may monitor DNA 105 in the presence of DNA repair enzymes to simulate cellular activity.

Radiation sensor 100 can be worn by a user via a belt clip, worn on a chain, carried in a pocket, etc. In one embodiment, radiation sensor 100 may be incorporated into an accessory that is worn by the user such as a piece of jewelry, a hair clip, eyeglasses, sunglasses, as part of a cell phone, on a key chain, incorporated into clothing, etc.

The DNA 105 used in radiation sensor 100 may be composed of single strand DNA (ss-DNA), double strand DNA (ds-DNA), or a combination of both ss-DNA and ds-DNA. In an illustrative embodiment, radiation sensor 100 includes one or more ds-DNA strands. In one embodiment, five ds-DNA strands are used. Alternatively, one, two, three, four, six, seven, ten, etc. ds-DNA strands are used. In another illustrative embodiment, radiation sensor 100 includes a minimum of 500 ds-DNA strands, each with 30 base pairs. In such an embodiment, a size of the DNA used can be comparable to that of mitochondria DNA. Alternatively, radiation sensor 100 can include 100 million ds-DNA, each with 30 base pairs. In one embodiment, each sensor unit of radiation sensor 100 can include 3×10⁹ base pairs separated by 10⁸ of a 30 base pair oligonucleotide DNA. In an embodiment in which multiple DNA strands are used, the different strands may have the same DNA sequence, or they may be different. DNA strands may be synthetic or isolated natural DNA strands. DNA strands may have human DNA sequence synthesized according to human DNA sequence or isolated from human tissues or cells. In one embodiment, any human DNA sequence can be used, and DNA 105 is not necessarily obtained from an end user of radiation sensor 100. Alternatively, DNA 105 may be obtained from the end user of the radiation sensor 100. The DNA 105 can be obtained using any method known to those of skill in the art.

In one embodiment, non-human DNA may be used in embodiments where radiation sensor 100 is used to detect radiation in animals. In such an embodiment, DNA 105 incorporated into radiation sensor 100 can be obtained from the type of animal that is to wear radiation sensor 100. For example, if a cow is to wear radiation sensor 100, DNA 105 can be obtained from a cow. Similarly, radiation sensor 100 can be used with other livestock animals, wild animals, pets such as dogs and cats, etc. Alternatively, the DNA used may be random and/or from a different organism than the organism that is to wear/use radiation sensor 100. For example, human DNA may be used in a radiation sensor designed for a cow or other animal. Similarly, cow DNA or DNA from a different animal may be used in a radiation sensor designed for a human.

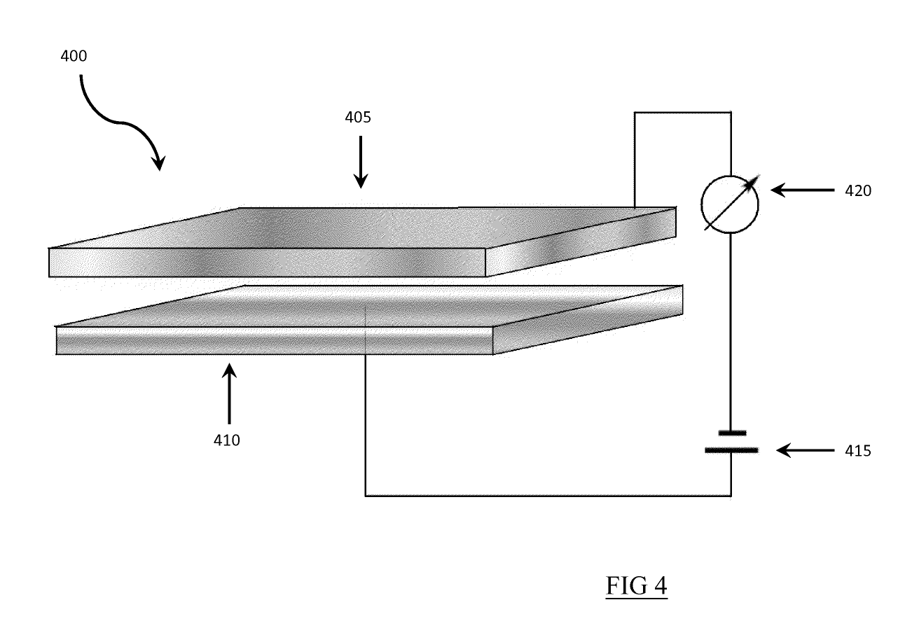

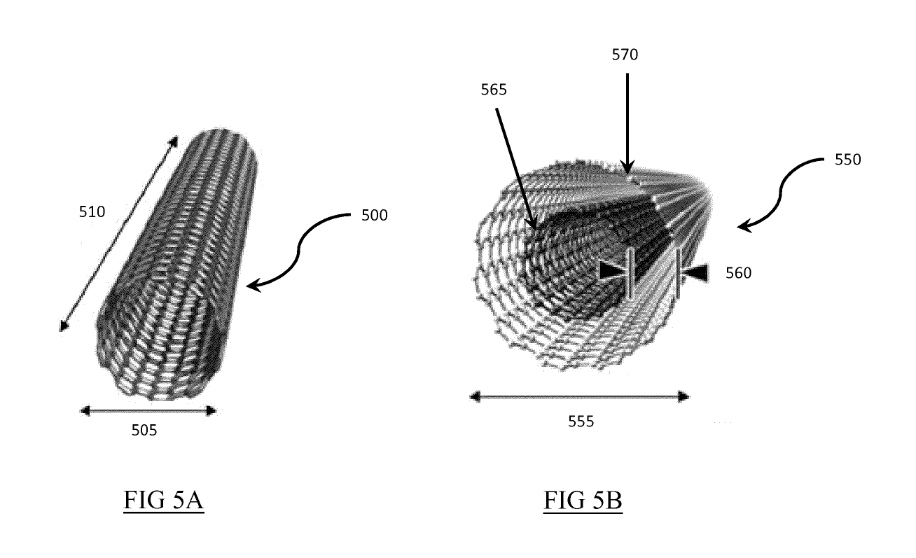

In an illustrative embodiment, DNA 105 is located between electrode 110 and electrode 115. If shorter strands of DNA 105 are used, electrode 110 and electrode 115 can be a distance of between approximately 10 nanometers and approximately 100 nanometers apart. Such a distance may be used for standard radiation sensors. If longer strands of DNA 105 are used, electrode 110 and electrode 115 can be a distance equal to or greater than 100 nanometers apart. Alternatively, the distance between longer strands of DNA can be between 90 and 110 nanometers, 80 and 120 nanometers, 70 and 130 nanometers, etc. Such a distance may be used for re-usable sensors (that is, sensors that incorporate a form of DNA self-repair) or sensors with embedded natural DNA fragments as opposed to synthetic oligonucleotide DNA. In another illustrative embodiment, electrode 110 and electrode 115 are a set of electrodes through which conductivity of DNA 105 is measured. In an alternative embodiment, two or more sets of electrodes may be used with DNA located between each of the sets of electrodes. Electrode 110 can be the same as electrode 115, or the electrodes can differ from one another, depending on the embodiment. In an illustrative embodiment, electrodes 110 and 115 may be composed of any conductive material such as gold, carbon nano-tubes, carbon nano-fibers, etc. Electrodes 110 and 115 may be flexible or rigid, depending on the embodiment. In one embodiment, electrodes 110 and 115 may be permeable or grid-like. An advantage of an embodiment utilizing permeable grid-like electrodes is that radiation can better penetrate the electrodes and reach the DNA, thereby giving the device greater sensitivity to radiation. Alternatively, electrodes 110 and 115 may be solid and/or impermeable. Various electrode configurations are described in more detail below with reference to FIGS. 4, 5a, and 5b.

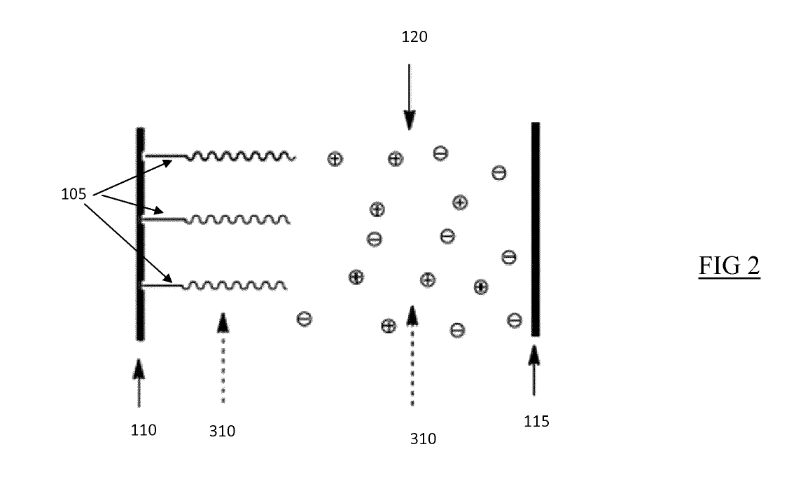

In an illustrative embodiment, at least one end of each strand of DNA 105 is mounted to an electrode, which can be either electrode 110 or electrode 115. In one embodiment, only one end of each strand of DNA 105 is mounted to an electrode, as illustrated in FIG. 2, which is discussed in more detail below. In an alternative embodiment, both ends of each strand of DNA 105 are mounted to an electrode. In such an embodiment, a first end of a strand of DNA 105 may be mounted to electrode 110 and a second end of the strand of DNA 105 may be mounted to electrode 115. In one embodiment, DNA 105 may be linked using any linker known to those of skill in the art. The DNA 105 may be mounted directly to the electrode using a covalent bond. The DNA 105 can be mounted to an electrode using a tether such as an alkanethiol tether. In one embodiment, during fabrication of radiation sensor 100, a ds-DNA can be formed on the surface of an electrode through self-assembly of a non-linked complementary strand of DNA with a DNA strand that is covalently linked (or otherwise mounted) to the electrode.

In one embodiment of radiation sensor 100, DNA 105 may be surrounded by and in communication with electrolyte 120. In an illustrative embodiment, the ion content in electrolyte 120 is limited such that the ions do not effect the sensitivity of radiation sensor 100. In one embodiment, electrolyte 120 may be composed of water. In another embodiment, electrolyte 120 may include biological material such as collagen, proteins, lipids, magnesium (Mg²⁺), etc. such that DNA 105 is in an environment that mimics the inside of a biological cell. In other embodiments, electrolyte 120 may contain any other material or combination of materials that may provide an analog for conditions inside of a biological cell. Placing DNA 105 in an environment that mimics a biological cell helps to ensure that any damage which occurs to DNA 105 in radiation sensor 100 is the same damage that would occur to DNA within a human (or animal) body.

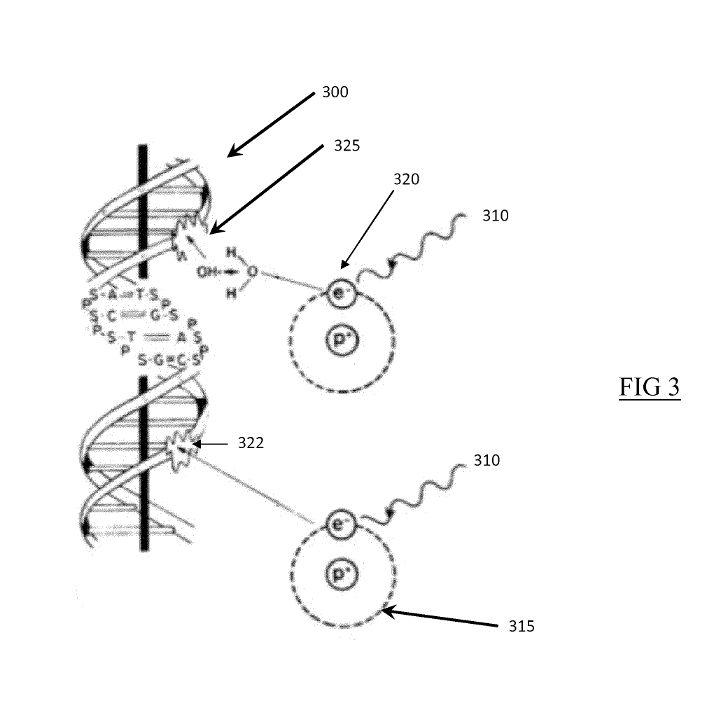

In one embodiment, radiation sensor 100 may include multiple sets of electrodes. Each set of electrodes can be isolated from one another in a separate chamber of radiation sensor 100, and each set of electrodes can have one or more distinct DNA strands mounted thereto. In addition, each of the one or more distinct DNA strands mounted to each set of electrodes can be surrounded by a different electrolyte. As an example, a first DNA strand mounted between a first set of electrodes can be surrounded by an electrolyte that includes collagen, a second DNA strand mounted between a second set of electrodes can be surrounded by an electrolyte that includes a protein, etc. In such an embodiment, radiation sensor 100 can be used to determine how different biological materials affect DNA when those biological materials are exposed to radiation. The effect that surrounding biological materials exposed to radiation may have on DNA, which is referred to as indirect action, is described in more detail with reference to FIG. 3. In an alternative embodiment, electrolyte 120 may not be used.

In an illustrative embodiment, conductivity sensor 125 is in electrical communication with electrode 110 and electrode 115 such that the conductivity between electrodes 110 and 115 and through DNA 105 can be measured. Conductivity sensor 125 can be an ammeter, conductivity meter, or any conductivity sensor known to those of skill in the art. In an illustrative embodiment, the conductivity is measured by applying a voltage across electrodes 110 and 115 and measuring the resulting current between electrodes 110 and 115. The voltage across electrodes 110 and 115 can be obtained from power source 150 or by a different power source associated with conductivity sensor 125. The resistance between electrodes 110 and 115 can be determined using Ohm's Law (voltage=current times resistance) as known to those of skill in the art. Conductivity can be determined by taking the inverse of the determined resistance. In an alternative embodiment, resistance may be the quality which is monitored to determine whether there is damage to DNA 105. In an illustrative embodiment, conductivity sensor 125 is in communication with computing device 130. Conductivity sensor 125 can be powered by power source 150, which can be a battery, solar panel, or any other power source known to those of skill in the art.

The highest measured conductivity between electrodes 110 and 115 results when DNA 105 is fully intact (that is, without any breaks). Additionally, a well-matched ds-DNA can have a higher conductivity than a mismatched ds-DNA, as described in Xuefeng Guo et al., Conductivity of a Single DNA Duplex Bridging a Carbon Nanotube Gap, National Institute of Health, available in PMC 2009 September 21. As such, in embodiments where DNA 105 is ds-DNA, each strand of the ds-DNA is matched such that initial conductivity of the ds-DNA is maximized. The DNA 105 can create an electrical connection between electrodes 110 and 115.

Upon exposure to radiation, DNA 105 may develop a break, either through direct action or indirect action. Direct action and indirect action are described in more detail below with reference to FIG. 3. When a break in DNA 105 occurs, the electrical conductivity between electrodes 110 and 115 is reduced, resulting in a changed conductivity measurement by conductivity sensor 125. For example, a break in DNA 105 may lower the conductivity. In an embodiment in which ds-DNA is used, the break in DNA can be either a single strand break or a double strand break. A single strand break can refer to a break in only one strand of a ds-DNA, whereas a double strand break can refer to a break in both strands of the ds-DNA. Normally, the human body can readily correct a single strand break, but can have difficulty correcting a double strand break. Therefore, in one illustrative embodiment, radiation sensor 100 can be configured to detect double strand breaks and provide an alert in the event of a double strand break.

In an illustrative embodiment, computing device 130 can receive conductivity measurements from conductivity sensor 125. The conductivity measurements can be taken continuously, periodically, or randomly depending on the embodiment. First data received by computing device 130 can include a first conductivity value of DNA 105 at a first time, as measured by conductivity sensor 125 through electrodes 110 and 115. The first conductivity value can be stored in memory 140. Computing device 130 can also receive second data from conductivity sensor 125, where the second data includes a second conductivity value of DNA 105 at a second time, as measured by conductivity sensor 125 through electrodes 110 and 115. The second conductivity value can also be stored in memory 140. In one embodiment, conductivity readings can be obtained by conductivity sensor 125 periodically, such as one reading every second, one reading every 30 seconds, one reading every minute, one reading every 10 minutes, one reading every hour, one reading a day, one reading a week, etc. In one embodiment, conductivity sensor 125 may determine the conductivity value of DNA 105 only after receiving a command from a user through a user interface (not shown) of computing device 130 or remotely through transceiver 145. A user interface of computing device can be a touch screen, one or more buttons, or any other interface known to those of skill in the art through which a user can interact with radiation sensor 100. In one embodiment, computing device 130 associates a timestamp with the conductivity value readings to indicate the time and date of each reading. Such timestamps can also be stored in memory 140.

In an illustrative embodiment, processor 135 of computing device 130 can compare the second conductivity value to the first conductivity value and determine whether there has been a change in conductivity of DNA 105. If the amount by which the second conductivity value is less than the first conductivity value exceeds a threshold, the user is notified. In an illustrative embodiment, the conductivity threshold corresponds to the change in conductivity that occurs as a result of exposure to approximately 0.2 Gray units (Gy) of radiation. Similarly, processor 135 of computing device 130 can compare a third conductivity value (which is obtained at a third time) to the first conductivity value to determine if the change in conductivity exceeds the threshold, and so on. In an illustrative embodiment, each subsequently obtained conductivity value is compared to the first obtained conductivity value such that radiation sensor 100 monitors the overall change in conductivity of DNA 105 from a first reading taken by radiation sensor 100 until a most recent reading taken by radiation sensor 100. In an alternative embodiment, the most recent reading taken by radiation sensor 100 may be compared to the next most recent reading taken by radiation sensor 100 (that is, the 33^{rd} reading may be compared to the 32^{nd} reading, etc.).

In an alternative embodiment, conductivity values may not be compared. In such an embodiment, if any given conductivity value is below a threshold indicative of a break, the user is notified. In an illustrative embodiment, the user is notified via alarm 148 of computing device 130. Alarm 148 can be implemented as any notification method known in the art including, but not limited to, a noise, a light, a vibration, etc. Alarm 148 can also wirelessly transmit an alert to a computing system through transceiver 145, etc. In one embodiment, the alert can be in the form of an e-mail, text message, or other written notification.

In an illustrative embodiment, transceiver 145 is configured to send data stored in memory 145 to another computing device such as a cell phone, a printing device, a laptop computer, a desktop computer, a tablet, etc. Transceiver 145 may be configured to transfer data wirelessly or through wires, using any protocol known in the art. Transceiver 145 may be configured to transfer any information stored on memory 145, including conductivity value readings and associated timestamps. Transceiver 145 can also receive remote instructions from a remote computer to have radiation sensor 100 take a conductivity reading. In one embodiment, transceiver 145 can automatically send an alert to a user, physician, or other party if conductivity readings indicate a DNA break or possible DNA break. Transceiver 145 can include any type of receiver, transmitter, or transceiver known to those of skill in the art.

In an illustrative embodiment, the components of radiation sensor 100 are contained in a single, self-contained unit that can be worn by a user or placed in a location where radiation may be present. The self-contained unit can be made from a durable plastic or any other material that will not interfere with conductivity readings. In an alternative embodiment, components of radiation sensor 100 may be detachable from one another. For example, DNA 105, electrodes 110 and 115, and electrolyte 120 may be in one unit that is detachable from conductivity sensor 125, computing device 130, and/or power source 150. In such an embodiment, the unit containing DNA 105, electrodes 110 and 115, and electrolyte 120 may be placed in electrical communication with conductivity sensor 125 and computer device 130 only when a conductivity reading is taken. In an illustrative embodiment, DNA 105 and at least a portion of electrodes 110 and 115 are encapsulated by an insulator within radiation sensor 100 such that electrolyte 120 (if present) can be contained and in contact with DNA 105. In one embodiment, radiation sensor 100 may include a plurality of independent units in which each unit includes distinct DNA, electrodes, and/or electrolyte. In another illustrative embodiment, each unit of radiation sensor 100 may represent a functional unit of cellular DNA or mitochondria DNA. In one embodiment in which a radiation sensor device includes a plurality of radiation sensor units, the change in DNA conductivity can be determined separately in each of the radiation sensor units, and an alarm or warning may be provided to the user only if the conductivity threshold is met in a predetermined percentage of the radiation sensor units. The percentage can be 0.01%, 0.1%, 0.5%, 1%, 5%, 10%, 25%, 50%, etc.

FIG. 2 illustrates three strands of DNA 105 mounted to electrode 110 in accordance with an illustrative embodiment. In an illustrative embodiment, radiation sensor 100 can be configured to detect a single break in any one strand of DNA 105. In one embodiment, DNA 105 may also be mounted to electrode 115. In an illustrative embodiment, the three strands of DNA 105 are ds-DNA. Alternatively, ss-DNA or a combination of ss-DNA and ds-DNA may be used. Also, fewer or additional strands of DNA may be used in alternative embodiments. As illustrated in FIG. 2, the three strands of DNA 105 are mounted to electrode 110 and extend toward electrode 115. In an embodiment in which electrode 110 is a carbon nanotube, the strands of DNA 105 can be mounted along the length of the carbon nanotube, as illustrated in FIG. 2. Alternatively, DNA 105 can be mounted to one or both ends of a carbon nanotube. FIG. 2 also illustrates electrolyte 120 as charged particles. Radiation 310 that may degrade DNA 105 is illustrated as dashed arrows. Any DNA fabrication technique known in the art may be used to prevent the multiple strands of DNA 105 from interfering with one another.

FIG. 3 illustrates two ways that radiation can cause breaks in a ds-DNA 300 in accordance with an illustrative embodiment. One method in which radiation causes breaks in ds-DNA 300 is referred to as direct action. Radiation 310 can be in the form of x-rays, gamma-rays, or any other type of radiation. As known to those of skill in the art, a DNA strand is made up of a string of molecules. In direct action, radiation 310 hits a molecule 315 of ds-DNA 300 directly, causing molecule 315 to break down. When molecule 315 breaks down, a break in the chain of molecules occurs, causing a break 322 in one strand of ds-DNA 300. In another method of causing breaks, referred to as indirect action, radiation 310 can hit a molecule 320 that is not part of ds-DNA 300. Molecule 320 can be a molecule of water. Alternatively, molecule 320 can by any molecule contained in electrolyte 120. In the example of molecule 320 as water, when molecule 320 absorbs radiation 310, a free radical is produced which can diffuse far enough to reach ds-DNA 300 and can cause a break 325 in ds-DNA 300. If radiation sensor 100 does not contain electrolyte 120, the sensor will only be able to detect breaks in ds-DNA 300 caused by direct action radiation because indirect action does not occur absent a material in communication with the ds-DNA 300.

In addition to DNA strand breaks, radiation can cause various types of damage to DNA such as base depletion, base change, deaminization, forming water adduct of base, forming pyrimidine dimer, cross-linkage to protein, etc. These forms of damage are generally repairable, whereas a break in the DNA strand is not. Also, such types of damage generally do not cause as dramatic of a change in conductivity as a break in the DNA strand. As such, in an illustrative embodiment, the sensor described herein is used to detect DNA strand breaks. In an alternative embodiment, the sensor may be used to detect changes in conductivity representative of other forms of DNA damage.

FIG. 4 illustrates a portion of a radiation sensor 400 with flat, sheet-like electrodes 405 and 410 in accordance with an illustrative embodiment. A DNA sample (not shown) can be located between electrodes 405 and 410 and mounted to at least one of electrodes 405 and 410. Additionally, electrolyte (also not shown) may be placed between electrodes 405 and 410. In one embodiment of radiation sensor 400, a ds-DNA can be immobilized on electrode 405, which can be made of gold, via an alkanethiol tether as known to those of skill in the art. Alternatively electrode 405 may be made from a different conductor and/or a different type of tether may be used to immobilize the ds-DNA. Electrode 410 can be a carbon nanotube film formed by growing carbon nanotubes on a silicon dioxide substrate using chemical vapor deposition as known to those of skill in the art. Alternatively, any other technique or method of producing a carbon nanotube film that is known in the art may be used. In another alternative embodiment, electrode 410 may be made from gold or another conducting material. Electrodes 405 and 410 can be enclosed using an insulator (not shown) to create a nano-sized chamber between electrodes 405 and 410 which can encompass the ds-DNA sample and the electrolyte, if electrolyte is used. Materials of construction for the insulator can be chosen such that radiation can permeate the insulator to reach the electrolyte and/or DNA. As a non-limiting example, polyolefin sulfone can be used as an insulator to enclose electrode 405 and electrode 410. In the embodiment of FIG. 4, radiation sensor 400 includes a power source 415, which can be a battery, and a conductivity sensor 420 for use in determining conductivity. In alternative embodiments, any other configuration that is capable of measuring a resistance or conductivity between electrodes 405 and 410 can be used. In alternative embodiments, the radiation sensor may have a different shape, such as a probe with a round surface.

FIG. 5a illustrates a single-walled carbon nanotube in accordance with an illustrative embodiment. As mentioned above, carbon nanotubes such as single-walled carbon nanotube 500 can be used as an electrode in the radiation sensor. The single-walled carbon nanotube 500 can have a diameter 505 and a length 510. In an illustrative embodiment, diameter 505 can range from 1-2 nanometers. In another embodiment, length 510 can range from 0.2 to 5 micrometers. However, one skilled in the art will appreciate that any length or diameter of a single-walled carbon nanotube can be used so long as the DNA can be mounted to the single-walled carbon nanotube.

FIG. 5b illustrates a double-walled carbon nanotube in accordance with an illustrative embodiment. Double-walled carbon nanotubes such as double-walled carbon nanotube 550 can be used as an electrode in the radiation sensor. Double-walled carbon nanotube 550 can have an outside diameter 555. As FIG. 5b illustrates, double-walled carbon nanotube 550 includes an inner single-walled carbon nanotube 565 and an outer single-walled carbon nanotube 570. The spacing between carbon nanotubes 565 and 570 can be a distance 560. Distance 560 can be approximately 0.36 nanometers in one embodiment. Alternatively, the distance can be between 0.3 and 0.4 nanometers, between 0.25 and 0.45 nanometers, etc. One skilled in the art will appreciate that any spacing known in the art can be used so long as the DNA can be mounted to double-walled carbon nanotube 550. Outside diameter 555 can range from 2-25 nanometers. However, one skilled in the art will appreciate that any outside diameter known in the art can be used so long as the DNA can be mounted to double-walled carbon nanotube 550.

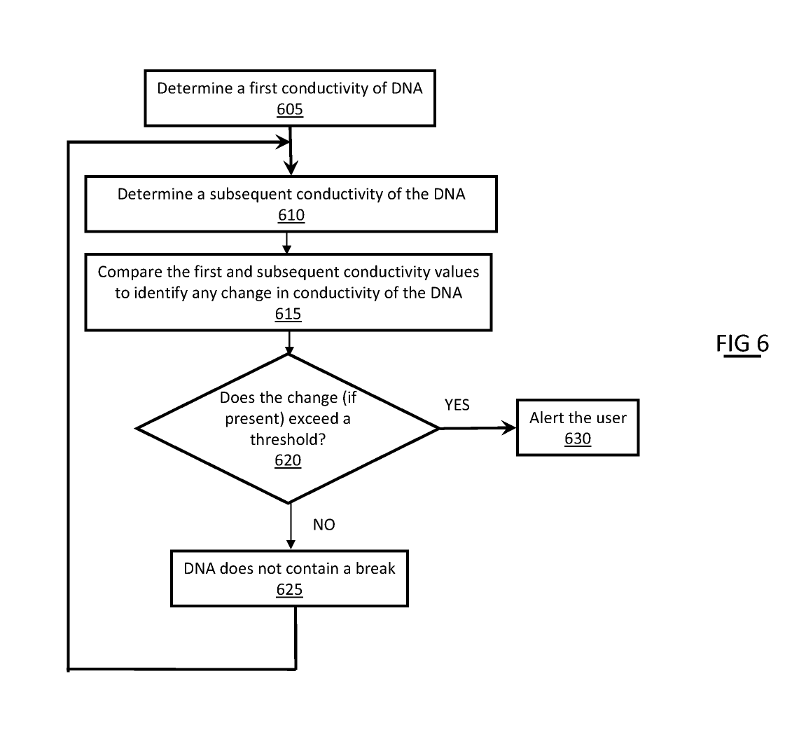

FIG. 6 is a flow chart illustrating one method of detecting radiation induced damage to DNA in accordance with an illustrative embodiment. In alternative embodiments, fewer, additional, and/or different operations may be performed. Also, the use of a flow diagram is not meant to be limiting with respect to the order of operations performed. In an operation 605, a first conductivity value of DNA is determined. In an illustrative embodiment, the DNA is embedded in a radiation sensor such as radiation sensor 100 described herein and the first conductivity value is obtained by a conductivity sensor such as conductivity sensor 125. The first conductivity value can be determined automatically by the radiation sensor based on a predetermined elapsed amount of time since a prior reading, or in response to a command from a user of the radiation sensor.

In an operation 610, a subsequent conductivity value of the DNA is determined. The subsequent conductivity value can be determined automatically by the radiation sensor based on a predetermined elapsed amount of time since the first conductivity value was obtained, or in response to a command from a user of the radiation sensor. In an illustrative embodiment, the first and subsequent conductivity values can be stored in a memory, such as memory 140, along with timestamps indicative of when the respective conductivity values were obtained. In an operation 615, the subsequent conductivity value is compared to the first conductivity value to identify any change in the conductivity of the DNA. In illustrative embodiment, the comparison and determination can be performed by processor 135 of computing device 130.

In an operation 620, a determination is made regarding whether the change in conductivity (if there is a change) exceeds a threshold. If there is no change in conductivity or if the change does not exceed the threshold, the radiation sensor determines that there is not a DNA break in an operation 625, and operations 610-620 are repeated. If it is determined that there is a change in conductivity of the DNA and that the change exceeds the threshold, an alert is provided to the user in an operation 630.

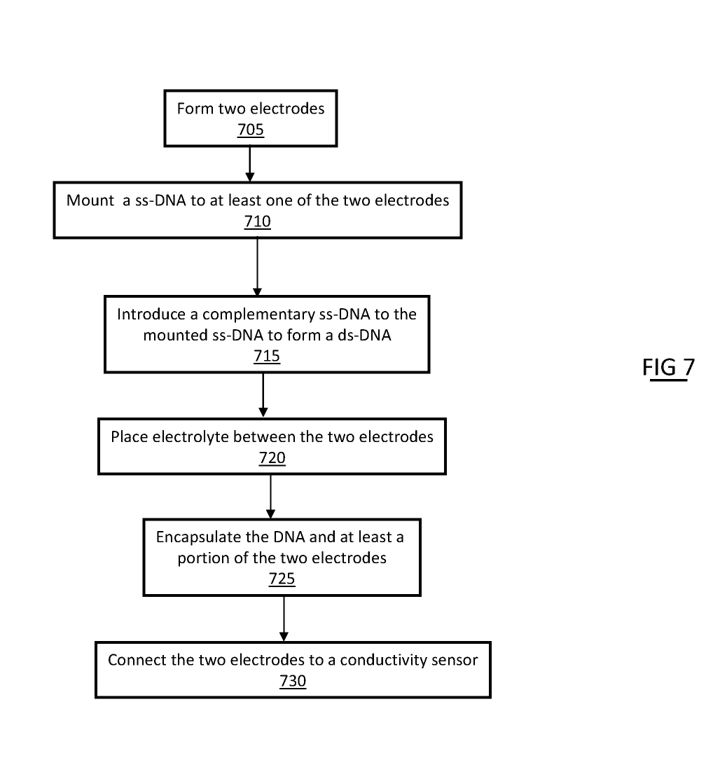

FIG. 7 is a flow chart illustrating one method of fabricating the sensing element of a radiation sensor in accordance with an illustrative embodiment. In alternative embodiments, fewer, additional, and/or different operations may be performed. Also, the use of a flow diagram is not meant to be limiting with respect to the order of operations performed. Operation 705 includes forming two electrodes. In alternative embodiments, more than two electrodes may be used in a radiation sensor that has multiple DNA chambers. The electrodes can be any combination of carbon nanotubes, carbon nano-fibers, gold, and/or any other conductor to which a DNA strand can be secured. Operation 710 includes mounting a ss-DNA to at least one of the two electrodes. The ss-DNA can be mounted according to any of the methods described herein, such as use of a linker, use of a tether, use of a covalent bond, etc. Operation 715 includes introducing a complementary ss-DNA to the mounted ss-DNA to form a ds-DNA. In an illustrative embodiment, a well matched ss-DNA can be introduced to the mounted ss-DNA to maximize conductivity of the assembled ds-DNA. The DNA strands can be matched using any techniques known to those of skill in the art. In one embodiment, the free (or un-mounted) ss-DNA self-assembles with the mounted ss-DNA to form the ds-DNA. Self-assembly of DNA is well known in the art. In an alternative embodiment, any other method known to those of skill in the art may be used to form and/or mount the ds-DNA. In another alternative embodiment, ss-DNA may be used in the radiation sensor instead of ds-DNA. Operation 720 includes placing electrolyte between the two electrodes. As described above, the electrolyte may include biological particles to mimic a natural environment of the DNA. Alternatively, electrolyte may not be used. Operation 725 includes encapsulating the DNA and at least a portion of the two electrodes to form a chamber that can contain any electrolyte and protect the DNA from damage. The encapsulation can be done using a non-conductive material that will not interfere with conductivity readings of the DNA. Operation 730 includes connecting the electrodes to a conductivity sensor. Any method known to those of skill in the art for connecting an electrode to a sensor may be used.

### EXAMPLES

### Example 1

### Reproductive System Radiation Sensor

A radiation sensor device is used to monitor radiation exposure of a reproductive system of an individual. The radiation sensor device is in the shape of a cube and is relatively small in size, having overall exterior dimensions of approximately 1 millimeter (mm) by 1 mm by 1 mm. The radiation sensor device includes a single radiation sensor unit having two electrodes made of gold. Mounted between the two electrodes are 100 double stranded oligonucleotide DNA strands. Each of the 100 double stranded oligonucleotide DNA strands is mounted to one of the two electrodes via an alkanethiol tether. An electrolyte that includes lipids is placed in between the two electrodes such that the electrolyte surrounds the DNA strands. The two electrodes, the 100 double stranded oligonucleotide DNA strands, and the electrolyte are encapsulated by polyolefin sulfone within the radiation sensor device. The polyolefin sulfone acts as an insulator such that accurate DNA conductivity readings can be obtained. The radiation sensor device also includes a microcomputer and a conductivity sensor in the form of a conductivity meter. The conductivity meter includes a power source for operating both the microcomputer and the conductivity sensor. The microcomputer includes a processor, memory, and a wireless transceiver.

In operation, the conductivity meter periodically measures the conductivity between the two electrodes. The period can be set by a user sending a wireless signal from a computing device to the wireless transceiver of the radiation sensor device, where the wireless signal indicates a desired length of the period. The period can be one measurement every minute, one measurement every hour, or one measurement every day. A record of each measurement is stored in the memory and analyzed by the processor of the microcomputer. The processor compares each conductivity measurement to an original conductivity of the radiation sensor device. The original conductivity is the conductivity between the two electrodes prior to any radiation exposure. If a difference between the measured conductivity and the original conductivity exceeds a predetermined threshold, an alert is sent to the user via the wireless transceiver. The predetermined threshold is the change in conductivity that results from exposure of the DNA strands to 0.2 Gy of radiation. The form of the alert can be designated by the user as either an e-mail or a text message.

The radiation sensor device is sized to be implanted within a female proximate to the ovaries of the female. As such, the radiation sensor device can monitor radiation exposure to the ovaries for the purpose of helping to determine whether there has potentially been any radiation damage to the reproductive system. Alternatively, the radiation sensor device may be mounted/worn externally by a male or female in an area proximate to the male/female reproductive system.

### Example 2

### Cellular Phone Radiation Sensor

A radiation sensor device is incorporated into a cellular phone and used to monitor radiation exposure of the cellular phone. The radiation sensor device is square in shape and has overall exterior dimensions of approximately 4 mm by 4 mm by 1 mm. The radiation sensor device includes four independent radiation sensor units. Each of the four radiation sensor units has two electrodes made of gold. Mounted between the two electrodes in each radiation sensor unit are 500 double stranded oligonucleotide DNA strands. In each radiation sensor unit, the 500 double stranded oligonucleotide DNA strands are mounted to one of the two electrodes via an alkanethiol tether. An electrolyte that includes collagen is placed in between the two electrodes in each radiation sensor unit such that the electrolyte surrounds the DNA strands. In each unit, the two electrodes, the 500 double stranded oligonucleotide DNA strands, and the electrolyte are encapsulated by polyolefin sulfone within the radiation sensor device. The polyolefin sulfone acts as an insulator such that accurate DNA conductivity readings can be obtained independently from each of the four radiation sensor units. The radiation sensor device also includes a microcomputer and a conductivity sensor in the form of a conductivity meter. The conductivity meter includes a power source for operating both the microcomputer and the conductivity sensor. The microcomputer includes a processor, memory, and a wireless transceiver. The power source is independent of the power source used by the cellular phone. As such, the radiation sensor unit is operable when the cellular phone battery is dead and when the cellular phone is turned off.

In operation, the conductivity meter periodically measures the conductivity between the two electrodes in each of the four radiation sensor units. The period can be set by a user sending a wireless signal from cellular phone to the wireless transceiver of the radiation sensor device, where the wireless signal indicates a desired length of the period. The period can be set to one measurement every second, one measurement every 30 seconds, one measurement every minute, or one measurement every hour in each of the four radiation sensor units. A record of each measurement is stored in the memory and analyzed by the processor of the microcomputer. The processor compares each conductivity measurement from a given radiation sensor unit to an original conductivity of that radiation sensor unit. The original conductivity is the conductivity between the two electrodes in the radiation sensor unit prior to any radiation exposure. If a difference between the measured conductivity and the original conductivity exceeds a predetermined threshold in any of the four radiation sensor units, an alert is sent to the user via the wireless transceiver. The predetermined threshold is the change in conductivity that results from exposure of the DNA strands to 0.2 Gy of radiation. The form of the alert can be designated by the user as either an e-mail or a text message.

The radiation sensor device is sized to be incorporated into the cellular phone. As such, the radiation sensor device can monitor radiation exposure of the cellular phone. For individuals who carry their cellular phone with them most or all of the time, radiation exposure of the cellular phone is representative of radiation exposure to the individual carrying the cellular phone. Alternatively, the radiation sensor device may be incorporated into a different device such as a portable gaming device, a tablet, a wristwatch, a laptop computer, etc.

Any of the operations described herein can be performed by computer-readable (or computer-executable) instructions that are stored on a computer-readable medium such as memory 140. The computer-readable medium can be a computer memory, database, or other storage medium that is capable of storing such instructions. Upon execution of the computer-readable instructions by a computing device such as a user device or a venue device, the instructions can cause the computing device to perform the operations described herein.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. An apparatus comprising:
a first electrode;
a second electrode positioned a distance from the first electrode, wherein the first electrode and the second electrode are configured to deliver electrical current through at least a portion of a double strand deoxyribonucleic acid (DNA); a detector configured to detect a conductivity of the double strand DNA based on the delivered electric current; and
a processor operatively coupled to the detector and configured to determine a breakage in the double strand DNA based at least in part on the detected conductivity.

2. The apparatus of claim 1, wherein at least one of the first electrode and the second electrode is configured to be linked with the double strand DNA.

3. The apparatus of claim 2, where at least one of the first electrode and the second electrode is configured to be linked with the double strand DNA directly or through a linker.

4. (canceled)

5. The apparatus of claim 1, wherein the processor is further configured to identify a change in conductivity of the double strand DNA, and wherein the change in conductivity is identified based at least in part on the detected conductivity of the double strand DNA.

6. The apparatus of claim 1, further comprising an alert mechanism configured to generate an alert responsive to the determined breakage.

7. (canceled)

8. The apparatus of claim 1, further comprising a power source configured to provide power to one or more of the detector and the processor.

9. The apparatus of claim 1, wherein at least one of the first electrode and the second electrode is permeable.

10. The apparatus of claim 1, further comprising an electrolyte positioned between the first electrode and the second electrode.

11. The apparatus of claim 10, wherein the electrolyte includes one or more biological materials.

12. The apparatus of claim 1, wherein at least one of the first electrode and the second electrode is configured to covalently link to the double strand DNA.

13. The apparatus of claim 1, wherein at least one of the first electrode and the second electrode comprises a carbon nanotube.

14. The apparatus of claim 1, wherein at least one of the first electrode and the second electrode comprises a substrate with at least a layer of carbon nanotubes.

15. The apparatus of claim 1, wherein the at least one of the first electrode and the second electrode comprises a silicon substrate.

16. A method of detecting radiation exposure, the method comprising:
coupling electric current to a double strand DNA via a pair of electrodes;
measuring a first electric current through the double strand DNA;
measuring a second electric current through the double strand DNA;
determining a first conductivity of the double strand DNA based on the first measured electric current;
determining a second conductivity of the double strand DNA based on the second measured electric current;
comparing the first conductivity with the second conductivity to identify a change in conductivity of the double strand DNA; and
determining that the double strand DNA has suffered a breakage based at least in part on the identified change in conductivity of the double strand DNA.

17. The method of claim 16, further comprising:
positioning wherein the double strand DNA between the pair of electrodes; and
linking the double strand DNA with at least one electrode of the pair of electrodes.

18. The method of claim 16, further comprising covalently linking the double strand DNA to at least one electrode of the pair of electrodes either directly or through a linker.

19. The method of claim 16, further comprising generating an alert responsive to the determined breakage of the double strand DNA.

20. The method of claim 16, further comprising placing an electrolyte between the pair of electrodes such that the electrolyte is in contact with the double strand DNA.

21. The method of claim 20, further comprising placing one or more biological materials in the electrolyte.

22. The method of claim 16, further comprising forming at least one electrode of the pair of electrodes from one or more carbon nanotubes.

23. A non-transitory computer-readable medium having computer-readable instructions stored thereon for execution by a computing device, wherein the computer-readable instructions comprise:
instructions to couple electric current to a double strand DNA via a pair of electrodes;
instructions to determine a first conductivity and a second conductivity of the double strand DNA by measuring the electric current through the pair of electrodes;
instructions to identify a change in conductivity of the double strand DNA based on the first determined conductivity and the second determined conductivity; and
instructions to a breakage in the double strand DNA based at least in part on the identified changed in conductivity.

24. The non-transitory computer-readable medium of claim 23, further comprising instructions to generate an alert responsive to the determined breakage of the double strand DNA.

25-28. (canceled)

29. An apparatus comprising:
a pair of electrodes configured to deliver electric current to at least a portion of a double strand deoxyribonucleic acid (DNA);
a detector configured to:
measure a first instance of the electric current delivered to the double strand DNA by the pair of electrodes; and
measure a second instance of the electric current delivered to the double strand DNA by the pair of electrodes; and
a processor operatively coupled to the detector and configured to:
determine a first conductivity of the double strand DNA based on the measured first instance of the electric current;
determine a second conductivity of the double strand DNA based on the measured second instance of the electric current;
compare the first conductivity with the second conductivity to identify a change in conductivity of the double strand DNA; and
determine that the double strand DNA has suffered a breakage based at least in part on the identified change in conductivity of the double strand DNA.

30. The apparatus of claim 29, further further comprising an alert mechanism operatively coupled to the processor and configured to generate an alert responsive to the determined breakage.
